(19) United States
(12) Patent Application Publication
(10) Pub. No.: US 2021/0061612 A1
(43) Pub. Date: Mar. 4, 2021

(54) ELEVATOR SYSTEM

(71) Applicant: KONE Corporation, Helsinki (FI)

(72) Inventors: Ari Koivisto, Helsinki (FI); Ari Hänninen, Helsinki (FI); Tommi Huotari, Helsinki (FI); Mikko Puranen, Helsinki (FI); Hannu Nousu, Helsinki (FI); Tapio Tyni, Helsinki (FI)

(73) Assignee: KONE Corporation, Helsinki (FI)

(21) Appl. No.: 16/990,309

(22) Filed: Aug. 11, 2020

(30) Foreign Application Priority Data
Aug. 27, 2019 (EP) 19193689.7

(51) Int. Cl. B66B 1/24; B66B 9/00

(52) U.S. Cl. CPC B66B 1/2491; B66B 9/003; B66B 2201/242; B66B 2201/24; B66B 2201/307

(57) ABSTRACT

An elevator system includes: an elevator control; a plurality of individually movable elevator cars driving in an elevator runway system including at least one elevator runway, preferably at least two elevator runways, whereby the number of elevator cars is higher than the number of elevator runways in the runway system. The elevator cars are movable in the elevator runway system via at least one drive system. Each of the elevator cars is provided with an identifier. The elevator system includes at least one reader device for the identifier and a car handling module in the elevator control processing the information on the elevator cars and their identifiers in connection with their position in the elevator system. The elevator system includes elevator cars differing in at least one parameter (differing parameter). The memory of the elevator control includes car parameters of the cars in operation in the elevator system and the elevator control is configured to use the car parameters in the control of the elevator system. The identifier includes information at least about the differing parameter, and the car handling module is configured to put out of use the car parameters of an elevator car that is to be put out of operation and/or to introduce the car parameters of an elevator car which is to be put into operation.

The present invention relates to an elevator system comprising an elevator control, a plurality of individually movable elevator cars driving in an elevator runway system comprising at least one elevator runway, preferably at least two elevator runways, whereby the number of elevator cars is higher than the number of elevator runways in the runway system. In this system the elevator cars are movable in the elevator runway system via a at least one drive system, and each of the elevator cars is provided with an identifier.

In such a so called multicar elevator system, multiple elevator cars are arranged to move independently in the runway system, generally a common hoistway system. These elevator cars may be propelled by a linear motor or a rack and pinion-system or the like.

The elevator system further comprises at least one reader device for the identifier and a car handling module in the elevator control.

Such an elevator system according to the basic principle of the present invention is known from WO 2018/177828 A1. This document discloses elevator cars which are provided with identifiers, such that unambiguous identification of the car, particularly its car position is possible, even in case of a communication fault between the car and elevator control. This way it can be assured that a correct elevator car is recovered in fault situation.

It is object of the present invention to improve an elevator system of the aforementioned type to be better able to handle different types of elevator cars.

The invention is solved with an elevator according to claim 1. Advantageous embodiments of the invention are subject matter of the dependent claims. Advantageous embodiments are furthermore specified in the description.

According to the invention the elevator system comprises elevator cars differing in at least one parameter (differing parameter). Such a parameter may be i.a. the car size, particularly the car height, the car decoration, car weight or even the car safety equipment, and/or the car configuration, e.g. for handicapped people.

The memory of the elevator control comprises car parameters of the cars in operation in the elevator system and the elevator control is configured to use the car parameters in the control of the elevator system. Via this measure the elevator control comprises information which is important for the movement and handling of the different cars in the runway system, e.g. about the car height and thus about the floor approach or the car weight, e.g. caused by different decoration, which is important for the idle torque to start the car movement. Further, it is possible that different elevator cars may have different transport and/or safety and/or drive properties connected with the identification code of each elevator. These properties are related to equipment of elevator cars, e.g. transport capability of disabled persons, elevators with high-quality design, VIP cars.

The elevator system is configured to put the elevator cars into/out of operation, e.g. dependent on the traffic demand or in case or maintenance. Cars put out of operation may be parked in places of the runway system where they do not disturb essentially the normal operation of the running elevator cars, e.g. in runway parts which are rarely used.

In this connection it is to be clarified that the term “elevator cars in operation” means that these cars are available for calls in the call allocation in the elevator system.

Alternatively, a parking place or storage place is connected with the runway system, where the elevator cars can be parked which are currently not in operation. The advantage of the parking place is that this place does not interfere with the normal elevator operation at all.

According to the invention, the identifier comprises information at least about the differing parameter. If for example cars with two or more different heights or different decoration equipment are used these car groups differ in that differing parameter. It is thus not absolutely necessary that each car gets a unique identifier, but that the groups with different parameters get different identifiers. Of course, the cars might differ in more than one parameter and of course each car might have a unique identifier which allows e.g. car tracking in the runway system, e.g. after a power-off accident.

In the above described system with more cars than runways, cars might be put out of operation caused by changing traffic intensity over the day or week or even if some of the cars need maintenance or have to be repaired. On that behalf the car handling module is configured to put out of use the car parameters of an elevator car that is to be put out of operation and/or to introduce the car parameters of an elevator car which is to be put into operation. By this measure the elevator control is on one hand able to retrieve the parameters of all elevator cars in operation and even of those elevator cars which are out or operation, i.e. parked in a not used area of the runway system and/or in the storage place. On the other hand with this information the elevator control is able to replace a certain kind of elevator car with the same type of elevator car or with a different one—as required. Thus, the car handling module is always informed which type of elevator cars are in operation and which type of elevator cars are available, e.g. for special tasks, e.g. adapted for handicapped or VIP persons. This technology even allows to use aside of the normal single deck elevators double deck elevators in traffic peak conditions to improve the general capacity performance of the elevator system.

In a preferred embodiment of the invention the car handling module comprises or is in a communicative connection with a system storage with identifiers and correlated parameters of the elevator cars connected to the elevator system, which parameters comprise at least the differing parameter. Via this measure the car handling system has memorized all relevant data about the different elevator car types (defined by the differing parameter(s)), irrespective whether they are in in operation or not, e.g. being parked.

Preferably, the car handling module is configured to put out of use the identifier and the correlated car parameters of an elevator car that is to be put out of operation from the memory of the elevator control and/or to introduce the parameters of an elevator car which is to be put into operation together with its unique identifier into the memory of the elevator control. The car handling module thus always works with an updated table of elevator cars and its correlated parameters, which facilitates the selection of special elevator cars for special tasks.

In a preferred embodiment of the invention the differing parameter is car size, particularly height, or car weight, decoration or special equipment for particular people, e.g. handicapped, single deck or double-deck car, special safety equipment etc.. Thus the system is able to handle several different types or groups of elevator cars, which differ in that at least one differing parameter.

Preferably, the elevator control might comprise separated call allocation parameters for the different elevator car groups and is thus be able to perform an optimized call allocation for each individual group of cars. In case of a demand a special car, e.g. for a handicapped person, could even be put into use in short time, e.g. less than one minute.

Preferably, the elevator control is configured to put an elevator into operation only after all its parameters are loaded into the working memory. Via this measure it is ensured that the elevator control got all relevant car parameters to ensure an economic and safe service for the passengers and which allows the adaption of the transport service to special demands, which are specified by or linked to the differing parameter(s).

In a preferred embodiment of the invention the differing elevator car is the car height and that the parameters of the elevator car comprise information on the stopping level at the floors. This measure allows the elevator system to adapt the stopping height of each car to its particular height. This might even include double-deck elevator cars, which only have a reduced number of stops compared to single deck elevator cars.

Advantageously, the elevator system comprises at least one parking place for the elevator cars connected to but preferably being located apart, e.g. aside of the runway system, which parking place is configured to take up at least one parked elevator car which is put out of operation. Whereas cars not in operation could generally be located in an area, which is not used in normal operation, a separate parking place allows the location of one or several elevator cars in connection with the runway system but out of the running area of the elevator cars in operation. The cars could therefore parked securely in the elevator system without affecting normal operation of the elevator system.

In this case the cars can be put into operation very fast as the parking place is connected to the runway system, e.g. by guide beams or stator beams of linear motor drives. The parking place is preferably located at a place quite easily allows access to the parked elevator cars, e.g. for repair or maintenance service. Thus, the parking place should be located in or above the uppermost floor, e.g. a roof technic floor and/or at or below the lowermost floor, i.e. in a underground floor and preferably extending aside of it. Via this measure the parking place is remote from but connected to the runway system. Thus, the elevator cars can instantly and easily move from the runway system to the parking place and vice versa. The parking place might preferably be connected with a control room of the elevator system. This enables the maintenance on the control as well as of the parked cars at one location in a safe way.

The parking place could be closed during maintenance time for putting elevator cars out of operation/into operation to avoid any car movement in the parking place during maintenance work. This ensures working safety essentially.

Preferably, in this case the elevator control is configured to drive an elevator car to be put out of operation to the parking place and/or to drive an elevator car to be put into operation from the parking place into the runway system. This allows a fast putting in/out of operation of an elevator car.

In a preferred embodiment of the invention the car handling module is configured to perform a car change only if the differing parameter of the elevator cars to be changed matches. Via this measure it is ensured that always the correlation of numbers of active cars of the different car groups is maintained.

Preferably, a reader device for car identifiers connected to the elevator control is located at the connection between the runway system and the parking place. Via this measure the identity and the car parameters—at least the differing car parameters—can be checked each time an elevator car is put into/out of operation. The car handling module of the elevator control should have a knowledge about the position of each individual elevator in the elevator system. By using this reader device in the connection this position data of each car can be confirmed or updated. Further, this allows the monitoring of the function of the car handling module.

Preferably, the drive system is a linear motor drive. Whereas it is possible to use all kinds of systems which allow an elevator driving along the runways in the runway system and being taken from them, e.g. rack and pinion drives, the use of a linear motor drive system provides particular benefits. Thus, elevator cars are able to be moved along horizontal and vertical runways in the runway system. The connection between these horizontal and vertical runways can be realised by rotatable stator beam parts which according to their turn position are extending horizontally or vertically. A further advantage of a linear motor drive is that the stator beams only may comprise stator teeth comprising stator rods extending along the runways, whereas the driving force generating part is/are the mover(s) mounted on each of the elevator cars. Thus, it is easy to drive the elevator cars in the runways widely independent from each other. Of course a general driving algorithm in the elevator control should be provided to avoid collisions between the cars.

The linear motor may comprise stator beams defining the horizontal/vertical or even angled trajectory of the elevator cars. The linear motor may further comprise a plurality of movers coupled to the elevator cars and co-acting with stator beams mounted in the runway system. The plurality of movers may be adapted to travel along the stator beams to move the elevator cars along the runways.

Preferably, the elevator cars are held releasably on the stator beams, which allows putting out of operation or replacement or change of an elevator car including the mover(s) connected thereto. If the elevator system comprises a parking place the stator beams preferably extend into the parking place so that the elevator cars can be driven into the parking place when putting them out of operation without releasing them from the stator beams.

Preferably the elevator control comprises different sets of control parameters for the elevator car groups with differing parameters. Accordingly the control of an elevator car is always optimized for its particular differing parameters, e.g. height, weight etc.

The invention also relates to a method for operating an elevator system according to the above specifications, wherein together with putting an elevator car into/out of operation the identifier and the correlated car parameters of the elevator car in question is added to/put out of use from the memory of the elevator control. With respect to the advantages of this solution reference is made to the description of the inventive elevator system.

Preferably, a setup of at least a part of the elevator control program is performed in case the differing parameter comprises safety parameters interacting with safety components of the elevator system. This enables the elevator control to include the specific safety issues of a particular car in the safety handling module of the elevator control for optimized safety in the elevator system.

In case a linear motor drive is used preferably the mover(s) may be coupled to the elevator car directly or to a sling or carrier of the car, if any. Of course, more than one mover may be coupled to one elevator car. The mover(s), sling or carrier may be secured to an elevator cabin with a detachable fixing, such that cabin can be released and replaced easily. In this case the linear motor parts of the elevator car, i.e. the movers and their mounting and eventually and sling of the system, may remain while the rest of the car, i.e. the cabin is changed at some storage location. This allows us to fetch a special cabin for some special need. This technology of changeable elevator cabins has the advantage that the numbers of car movers and cars slings can be reduced compared with a technology where the complete car is changed. Such a system is therefore more cost effective. The disadvantage is the longer time to replace a certain car by another one, as each time the cabin has to be separated from the car sling and movers and the new cabin has to be fixed to them.

Different cars may have their floor level slightly or significantly different, so the motor and sling system must know this and stop at different positions when approaching a floor. This offset for each car can be stored in the system or read directly from the car by the motor+sling combination, adjusting its stops automatically.

Interchangeable cars may have different floor levels, so this invention corrects the problem. The different cars are acknowledged by the elevator control via their identifiers and the floor level is corrected automatically.

The elevator control preferably has a tracking algorithm which follows an identified elevator car over its paths in the runway system. This has the advantage that it is sufficient to read the car ID and thus to confirm the car position in larger intervals.

In an aspect of the invention, the multicar elevator system is provided with interchangeable cars and the elevator system may have a storage space for cars. A car in the elevator system may be replaced with another one from the car storage space.

Elevator cars may have different properties, which impact elevator control, for example, through different elevator control parameters. These properties may be, for example, different weight of elevator cars, different floor level position of elevator cars, different door operator parameters of elevator cars, different power consumption of elevator cars, different display information rendered on displays of different elevator cars, etc..

Different weight of elevator cars may be for example due to different decoration of elevator cars, or different materials or dimensions of elevator cars. Different floor levels may be caused by different height of elevator cars or different fixing points of elevator cars to the mover/sling/carrier. Different door operator parameters may be, for example, different door opening/closing times of respective door operators or different closing or opening torque of respective door operators. Different display information of cars may be, for example, different graphical information rendered on the display inside the elevator car. This may be due to different physical dimension of displays of different elevator cars or different preferences as regards to style or the information to be rendered.

It is also possible that different elevator cars have different safety equipment, which is brought into the elevator safety system when a car is replaced. These safety equipment may be, for example, different car brakes, different safety gear, different buffers or safety rail, different position and movement sensors of different elevator cars, different hatches or movable maintenance structures of different elevator cars etc.. These different safety equipment may have an effect on operation of elevator safety system, such as on operation on elevator safety controller. For example, different car brakes/safety gear may have an effect on emergency stopping distance of elevator car or deceleration during emergency stopping of an elevator car. Different position/movement sensors may require different scaling in elevator control, different initiation runs etc.. Different hatches/movable maintenance structures may have an effect for example on elevator maintenance operation mode or rescue operation mode.

The different identifiers or differing parameters may also comprise or relate to the car speed and/or car acceleration. The car speed and/or acceleration usually depend on certain characteristics of the car as e.g. the size and weight and has an essential impact on the functionality of the whole elevator system. On that behalf, the different cars may also have a differing numbers of movers.

This invention thus enhances the control of the different elevator cars (according to the differing parameter(s)).

The elevator cars are configured such that they can be identified by the elevator controller via their identifiers. This identification may be carried out with any suitable way, such as with serial numbers or identifiers associated with the cars (e.g. RFID tags, QR code, barcode, electrical memory components etc.). Each elevator car even may comprise a unique identifier which facilitates position detection/monitoring of each individual car.

The elevator system preferably is provided with a memory or a server associated therewith, and different parameters of different elevator cars are indexed with the identification of respective elevator cars. Preferably, when a car is replaced with another car in the elevator system,
the control parameters of the replaced elevator car are removed from the working memory of elevator controller and
the control parameters of the newly introduced car are retrieved from the memory/server to the working memory of the elevator controller.

Advantageously in this case control parameters that are related to normal elevator operation are introduced into that part of working memory that takes care of normal elevator operation.

Preferably, if the control parameters are related to elevator safety operation, i.e. elevator safety system, they are introduced into that part of working memory that takes care of safety operation (e.g. memory of programmable safety controller).

In a preferred embodiment of the invention the driving with the newly introduced car is not possible before the change of all required parameters has been successfully verified. This feature enhances the safety of the elevator system.

It is also possible that additional measures, such as additional setup run is required before elevator car is introduced into normal operation. This is the case especially when one or more parameters related to elevator safety operation has been changed.

Generally, all the parameters of all cars could be stored in same memory of the elevator control, or that parameters are retrieved from an external storage, such as (cloud) server etc . . . . In practice it could be that each car has its own frequency converter and/or its control with its own memory, and the car-dependent parameters are memorized in the control of the frequency converter. Then when car is replaced, the frequency converter and/or its control are associated with new car, and new car parameters (car weight etc..) are loaded to the frequency converter and/or its control from the system storage. So in practice here the term “elevator control” also contains drive units, e.g. frequency converters and/or its controls.

Following terms are used as a synonym: stator pole—stator tooth—tooth; normal—perpendicular—90 degrees; parking place/area—storage place/area; elevator car in service—elevator car in operation—running elevator car—elevator car available for calls in the allocation system; operation—use—service; car group—group of elevator cars with identical differing parameter; elevator group—elevator type;

The invention is now described in greater detail in connection with the enclosed drawings. In these show:

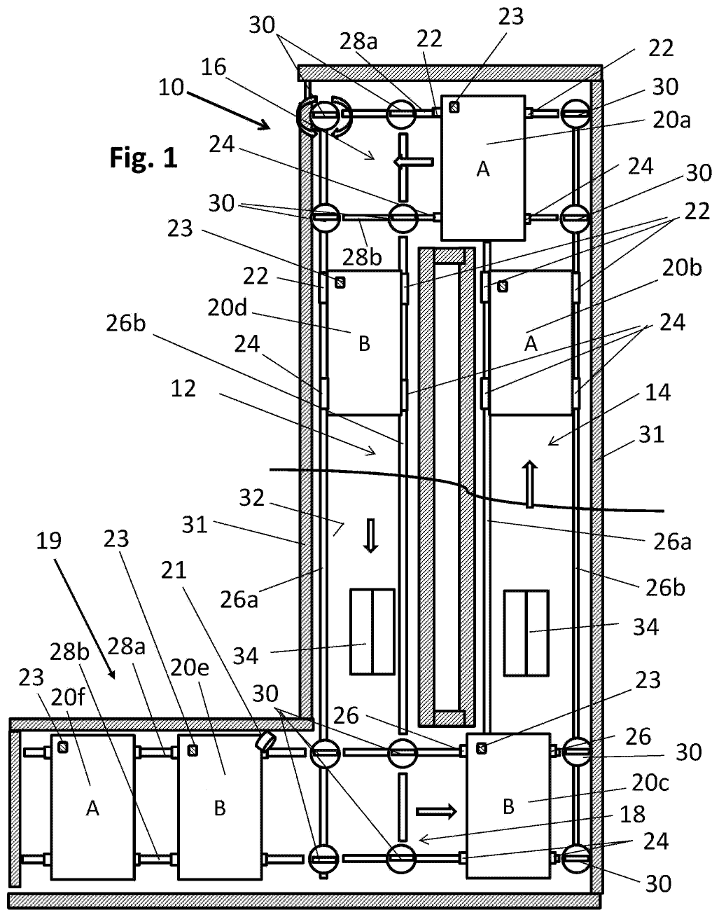

FIG. 1 a side view of an elevator with two elevator runways having vertical and horizontal stator beams acting together with movers pivoted at several elevator cars moving in those runways,

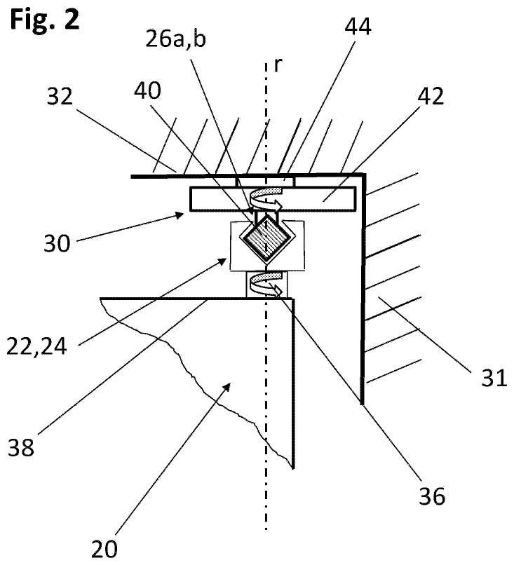

FIG. 2 a horizontal cross-section in the corner area between the elevator runway and the elevator car showing a rotatable stator beam part co-acting with a rotatably pivoted mover of the elevator car,

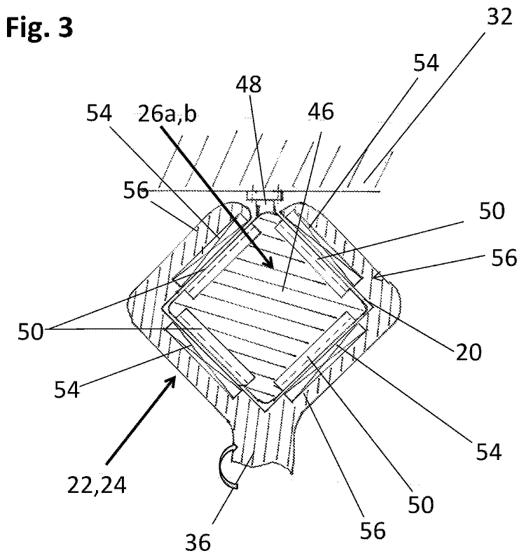

FIG. 3 a vertical stator beam co-acting with a mover of the elevator car,

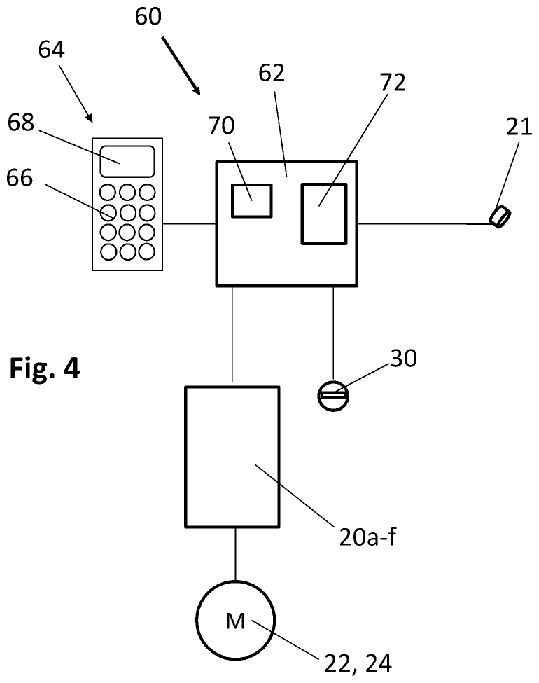

FIG. 4 a schematic diagram of the system control equipment of the elevator system of FIG. 1.

FIG. 1 shows an elevator 10 as an example of a passenger conveyor, having a runway system with two vertical elevator runways 12, 14 which are at least at their upper and lower ends connected by horizontal runways 16, 18. In this runway system 12, 14, 16, 18 the elevator cars 20a-20d are movable via linear motors. The linear motors are formed by upper movers 22 and lower movers 24 which are rotatably mounted, i.e. pivoted to the back side of the elevator cars, co-acting together with vertical stator beams 26a,b, horizontal stator beams 28a,b and with rotatable stator beams parts 30 which are rotatably mounted to a common back wall 32 of the vertical and horizontal runways 12, 14, 16, 18. The vertical elevator runways 12, 14 are usually located between runway walls 31 of a building. Each car 20a-20f has its own car identifier 23, which might be a bar code , QR-code, RDIF or a corresponding per se known identification device. The car identifiers comprise at least a differing parameter which assigns the cars to different elevator A,B which differ in size, weight, decoration, equipment etc.

Via the arrangement of vertical stator beams 26a,b and horizontal stator beams 28a,b and the rotatable stator beam parts 30 located in between them, the elevator cars 20a-20d are able to move via their movers 22, 24 in the two vertical elevator runways 12, 14 and in the two horizontal elevator runways 16, 18 in a trajectory path as indicated by the arrows. The advantage of such a solution is that no counterweights and no hoisting ropes are necessary which makes this basic concept very useful for high buildings as skyscrapers wherein the vertical length of the elevator runway is more or less unlimited. A height limiting factor for conventional traction sheave elevators was the weight of the elevator ropes, which sum up in high runways to a weight of tons. This restriction is not present in this linear motor based elevator concept.

With the reference number 34, landing doors are indicated which are preferably located in the common sidewall facing the viewer, i.e. opposite to the common back wall 32 where the stator beams 26a,b, 28a,b are mounted. But of course the landing doors could also be on the same back wall 32 or where the stator beams are mounted.

The lowermost horizontal runway 18 is connected to a parking place 19 which is located aside of the two vertical elevator runways 14, 16 and is able to take up two elevator cars 20e, 20f which are not in operation and/or are to be maintained or repaired. Not in operation means that the elevator cars are not available for any calls given in the elevator system. At the entrance of the parking place 19 a reader device 21 is located and connected to the elevator control. Via the reader device 21 the single car identifiers 23 can be read so that the elevator control gets information about the differing car parameter(s), according to which the car either belongs to group A or B. Possibly the identifier might comprise unique identification data so that each single elevator can be identified by the elevator control. Of course, further reader devices 21 could be located in the runway system.

FIG. 2 shows the co-action of the rotatable stator beam parts 30 and the movers 22, 24 which are via a pivoted joint 36 rotatably mounted to a wall, particularly to a back wall or support structure 38 of the elevator car 20. The rotatable stator beam part 30 and the mover 22,24 are rotatable around a common rotation axis r. The rotatable stator beam part 30 comprises a beam section 40 which abuts in the vertical direction (as indicated) with the vertical stator beams 26a, 26b and in horizontal direction with the horizontal stator beams 28a,b. The beam sections 40 are optionally mounted to a rotating disc 42 which is pivoted via a bearing 44 to the back wall 32 of the elevator runway whereby preferably either the rotating disc 42 and/or the mover 22, 24 is driven with a rotation drive around the common rotation axis r. Thus, the whole arrangement of rotatable stator part and mover can be rotated with only one rotating drive. During the rotation, the linear motor is switched off so that the mover 22, 24 and the beam section 40 are via the magnetic force between the stator section and the mover 22, 24 fixedly attached to each other which keeps the car from moving during change of trajectory path. Accordingly, a brake for keeping the mover 22, 24 and the beam section 40 of the rotatable stator beam part 30 together is not necessary. Anyway, an additional separate brake device may be introduced to keep the mover fixed to the rotatable start beam part 30 during rotation. This may be necessary in alternative embodiments where the magnetic force would not otherwise be adequate, for example, in embodiments wherein the stator poles are implemented with magnets, such as Halbach arrays, and the rotor coils of the mover are air core coils, i.e. the rotor is implemented without ferromagnetic core. After the whole arrangement has turned into the horizontal direction, the beam section 40 is now in line with the horizontal stator beams 28a, 28b and the mover 22, 24 can again be energized as to convey the elevator car 20a-d along the horizontal elevator runways 16, 18.

FIG. 3 shows a horizontal cross-section of the vertical stator beam 26a,b and the mover 22, 24. Accordingly, the vertical stator beam 26a,b comprises a stator beam 46 with square cross section having on its sides four stator faces 50 comprising stator teeth 52. The mover 22, 24 comprises active parts 54 located in a C-shaped mover housing 56 surrounding the stator beam 46, which active parts 54 face the corresponding stator faces 50 of the stator beam 46 as to generate an upwards directed propulsion force which is able to drive the elevator car 20a-d against the gravity force in upwards and downwards direction. The mover housing 56 together with the active mover parts 54 form the movers 22, 24 of the linear motors of the elevator. The mover housing 56 is via the pivot joint 36 mounted to a support structure 38 of the car 20. The stator beam 46 is supported with mountings 58 to the back wall 32 of the elevator runway 12, 14, 16, 18. The physical properties of the four different stator faces 50 of the vertical stator beam 26a,b and the physical properties of the corresponding active mover parts 54 of the mover 24, 25 are preferably identical.

FIG. 4 shows the system control equipment 60 of the elevator system 10. The system control equipment 60 comprises an elevator control 62 which is connected with call giving devices 64, e.g. destination control panels with a decade keyboard 66 for inputting a destination floor as well as a display 68 for indicating the allocated elevator car 20. Alternatively the call giving devices 64 might be simple up/down push button panels.

The elevator control 62, usually a group control, is further connected with each elevator car 20a-20f, particularly with its movers 22, 24 and their control. Via this connection the elevator control 62 is able to move each elevator car individually in the runway system 12, 14, 16, 18 of the elevator system 10 as well as in the parking place 19. Further, the elevator control 62 is connected with the rotation drive of each rotatable stator beam part 30. Together with the mover control of each single elevator car 20a-f the elevator control is thus able to steer each elevator car 20a-d individually through the runway system 12, 14, 16, 18 in order to serve calls input by the call giving devices 64 in the elevator system 10, and allocated by a per se known allocation control part of the elevator control 62, which realises an optimized call allocation under the consideration of different ride parameters as. Riding time, waiting time, energy consumption etc..

Further the elevator control 62 is connected with the at least one reader device 21, located in the runway system 12, 14, 16 ,18 and/or in the parking place 19 and/or in the connecting area in between.

The elevator control 62 comprises a car handling module 70 as well as a memory 72 which comprises data necessary for the operation of the elevator system 10 and possible data about the components in the elevator system 10.

The system control equipment 60 of the elevator system 10 works as follows:

In the above described system of FIG. 1 comprising more cars 20a-f than runways 12, 14, 16, 18, cars 20a-f might be put out of operation caused by changing traffic intensity over a time span, e.g. the day or week or even if some of the cars 20e, 20f need maintenance or have to be repaired. On that behalf the car handling module 70 is configured to put out of use the car parameters of an elevator car 20a-f that is to be put out of operation and/or to introduce the car parameters of an elevator car 20a-f which is to be put into operation. Of course, the action does not need to comprise a complete change of an elevator car but can only the putting of a car out of operation or putting a car into operation, e.g. in adaption to changing traffic conditions. Hereby, the elevator control 62 is on one hand able to retrieve the parameters of all elevator cars 20a-d in operation and even of those elevator cars 20e,f which are out or operation, i.e. parked in the parking place 19 of the elevator system 10. On the other hand with this information at least the differing parameter comprised in or linked with the car identifier 23 the elevator control 62 is able to replace a certain kind A, B of elevator car 20a-d with the same type A,B of elevator car 20e,f or with a different one—as required. Thus, the car handling module 70 is always informed which type A, B of elevator cars are in operation and which type of elevator cars are available, e.g. for special tasks, e.g. adapted for handicapped or VIP persons. This technology even allows to use—additionally to the normal single deck elevators—double deck elevators in traffic peak conditions to improve the general capacity performance of the elevator system. If the car identifiers are unique they can be used to identify and/or to confirm the position of each single elevator car 20a-f in the elevator system 10.

### LIST OF REFERENCE NUMBERS

10 elevator—passenger conveyor
12 first (vertical) elevator runway
14 second (vertical) elevator runway
16 upper horizontal runway
18 lower horizontal runway
19 parking place/area—storage place/area
20 elevator car
21 reader device for car identifiers
22 upper car movers
23 car identifiers comprising information at least about a differing parameter of each car
24 lower car movers
26a,b vertical stator beams
28a,b horizontal stator beams
30 rotatable stator beam parts between the horizontal and vertical stator beams
31 elevator runway walls
32 common back wall of all elevator runways carrying the stator beams
34 landing doors
36 pivoted joint between the car and the mover
38 (back) wall or support structure of the elevator car for mounting the pivoted joint
40 stator section fixed to rotating disc of rotatable stator beam part
42 rotating disc
44 bearing for the rotating disc on the back wall of the elevator runway
46 stator beam with square horizontal cross section having on its four side faces a stator face each
48 mountings for the stator beam to the back wall of the elevator runway
50 stator face with stator poles/teeth
54 active mover parts of the mover facing the stator faces of the stator beam
56 mover housing carrying the active mover parts surrounding the stator beam
60 system control equipment of the elevator system
62 elevator (group) control
64 call giving device
66 decade keyboard
68 display
70 car handling module
72 memory
A,B different groups or types of elevator cars as specified by the differing parameter(s)
r common rotation axis of rotatable stator part and mover

1. An elevator system comprising:
an elevator control;
a plurality of individually movable elevator cars driving in an elevator runway system comprising at least one elevator runway, wherein the number of elevator cars is higher than the number of elevator runways in the runway system, the elevator cars are being movable in the elevator runway system via at least one drive system, and each of the elevator cars being provided with an identifier;
at least one reader device for the identifier, and
a car handling module in the elevator control processing the information on the elevator cars and their identifiers in connection with their position in the elevator system;
wherein the elevator cars with respect to at least one parameter (differing parameter),
wherein the memory of the elevator control comprises car parameters of the elevator cars in operation in the elevator system,
wherein the elevator control is configured to use the car parameters in the control of the elevator system,
wherein the identifier comprises information at least about the differing parameter, and
wherein the car handling module is configured to put out of use the car parameters of an elevator car that is to be put out of operation and/or to introduce the car parameters of an elevator car which is to be put into operation.

2. The elevator system according to claim 1, wherein the car handling module comprises or is in a communicative connection with a system storage with identifiers and correlated parameters of the elevator cars connected to the elevator system, the parameters comprising at least the differing parameter.

3. The elevator system according to claim 1, wherein the car handling module is configured to put out of use the identifier and the correlated car parameters of an elevator car that is to be put out of operation from the memory of the elevator control and/or to introduce the parameters of an elevator car which is to be put into operation together with its unique identifier into the memory of the elevator control.

4. The elevator system according to claim 1, wherein the differing parameter is car size or car weight, car speed, car acceleration, number of movers, decoration or special equipment for particular people.

5. The elevator system according to claim 1, wherein the elevator control is configured to put an elevator into operation only after all its parameters are loaded into the working memory.

6. The elevator system according to claim 1, wherein the differing parameter is the car height and wherein the parameters of the elevator car comprise information on the stopping level at the floors.

7. The elevator system according to claim 1, wherein the elevator system comprises at least one parking place for the elevator cars connected to the runway system, the parking place being configured to take up at least one parked elevator car which is put out of operation.

8. The elevator system according to claim 7, wherein the elevator control is configured to drive an elevator car to be put out of operation to the parking place and/or to drive an elevator car to be put into operation from the parking place into the runway system.

9. The elevator system according to claim 7, wherein the parking place is located at the topmost and/or lowermost floor of a vertical runway and extending aside of the vertical runway.

10. The elevator system according to claim 7, wherein a reader device for car identifiers is connected to the elevator control and is located at a connection between the runway system and the parking place.

11. The elevator system according to claim 1, wherein the elevator cars in operation are interchangeable in the elevator system.

12. The elevator system according to claim 1, wherein the car handling module is configured to perform a car change only if the differing parameter of the elevator cars to be changed matches.

13. The elevator system according to claim 1, wherein the drive system is a linear motor drive.

14. The elevator system according to claim 13, wherein the linear motor drive comprises movers mounted at the elevator cars, the movers co-operating with stator beams mounted in the runway system.

15. The elevator system according to claim 14, wherein the elevator cars are held releasably on the stator beams.

16. The elevator system according to claim 1, wherein the elevator control comprises a different set of control parameters for the elevator cars with differing identifiers and/or differing parameters.

17. A method for operating the elevator system according to claim 1, wherein together with putting an elevator car into/out of operation, the identifier and the correlated car parameters of the elevator car is added to/put out of use from the memory of the elevator control.

18. The method according to claim 17, wherein a setup of at least a part of the elevator control program is performed in case the differing parameter comprises safety parameters interacting with safety components of the elevator system.

19. The elevator system according to claim 2, wherein the car handling module is configured to put out of use the identifier and the correlated car parameters of an elevator car that is to be put out of operation from the memory of the elevator control and/or to introduce the parameters of an elevator car which is to be put into operation together with its unique identifier into the memory of the elevator control.

20. The elevator system according to claim 2, wherein the differing parameter is car size or car weight, car speed, car acceleration, number of movers, decoration or special equipment for particular people.
